(19) United States
(12) Patent Application Publication
(10) Pub. No.: US 2017/0262903 A1
(43) Pub. Date: Sep. 14, 2017

(54) Web Server Linking Push and Pull Content

(71) Applicant: Russell S. Burnett, Murray, UT (US)

(72) Inventor: Russell S. Burnett, Murray, UT (US)

(21) Appl. No.: 15/068,018

(22) Filed: Mar. 11, 2016

(51) Int. Cl. G06Q 30/02

(52) U.S. Cl. CPC G06Q 30/0277; G06Q 50/16

(57) ABSTRACT

A system comprising a computer network, a site server hosted on the computer network, and a database hosted on the computer network. The database may store primary ads and collateral ads. Each primary ad may include a descriptor. Each collateral ad may include a display criterion. The site server may be programmed to receive a query and identify from the database primary ads satisfying the query. The site server may further be programmed to identify from the database collateral ads having a display criterion satisfied by the descriptor of at least one of the identified primary ads. The site server may further be programmed to simultaneously display the at least one identified primary ad and at least one collateral ad of the identified collateral ads.

### BACKGROUND

1. The Field of the Invention

This invention relates to advertising over a computer network and, more particularly, to novel systems and methods for displaying to a consumer, ads that are relevant to the needs of that consumer.

2. The Background Art

Advertising over computer networks is a growing business. However, some of the characteristics of computer networks dilute the value of advertising thereon. For example, the World Wide Web permits a consumer in one part of the world to easily view the site sponsored by an entity located very distantly therefrom. Accordingly, if that entity desires to sell advertising space on its site, it may have a challenging time customizing the ads to the particular viewers, as those viewers may have greatly divergent needs and desires. Thus, the value of the advertising space is diminished.

Accordingly, systems have been built to customize the ads presented to different consumers over computer networks such as the World Wide Web. With customization, those owning the advertising space have won greater compensation from advertisers. Significant portions of those systems have sought to statistically analyze the consumer. Statistical systems present ads to customers based on measured trends or patterns of consumption. Other systems try to guess the needs and desires of a consumer by tying certain key words to ads. Accordingly, when a user enters those words (e.g., into a search engine), the site presents ads from advertisers who have selected or identified those key words.

The current systems are limited in the granularity and focus that they can provide. What is needed is a deterministic system ensuring a high relevance between the needs and desires of a consumer and the ads present thereto.

### BRIEF SUMMARY OF THE INVENTION

In view of the foregoing, in accordance with the invention as embodied and broadly described herein, a method and apparatus are disclosed in one embodiment of the present invention as including a system comprising a site server and a database. A site owner or site manager may use such a system to provide content stored in the database to various users or consumers. In general, the content may be something of worth to, or sought by, the consumers. Accordingly, the consumers may be motivated to use the system and access the content.

By attracting consumers, a site owner may also attract advertisers. In selected embodiments, advertisers may compensate a site owner for advertising exposure. The amount of that compensation may vary widely depending on the value provided by the site owner to the advertiser. In general, an advertiser may be willing to provide greater compensation for greater exposure or a greater number of contacts. Similarly, an advertiser may be willing to provide greater compensation for higher quality exposure or contacts. Thus, to maximize advertising revenue, a site owner may seek to increase the exposure as well as the quality of the exposure.

In selected embodiments, a system in accordance with the present invention may display both primary ads and collateral ads. Primary ads may be those directly sought by a consumer. Collateral ads may be those indirectly sought by a user. For example, a consumer may use a system to search for an antique or classic car for purchase. Accordingly, the primary ads retrieved and displayed for the consumer may be antique or classic cars. However, certain antique or classic cars are in need of restorative services or parts. Collateral ads may be those advertising restorative services, hard-to-find automobile parts, or the like.

The database of a system in accordance with the present invention may store various primary ads and collateral ads. Each primary ad may include a descriptor describing some aspect of the primary ad or the goods or services offered in the primary ad. Each collateral ad may include a display criterion. The site server of the system may be programmed to receive a query from a consumer and identify from the database primary ads satisfying the query. The site server may then display to the consumer one of those primary ads.

Meanwhile, the site server may further be programmed to identify from the database collateral ads having a display criterion satisfied by the descriptor of the primary ad to be displayed to the consumer. The site server may further be programmed to simultaneously display, with the primary ad, at least one collateral ad of those having a display criterion satisfied by that primary ad.

In selected embodiments, a system in accordance with the present invention may include primary ads comprising real estate listings. For example, a primary ad may be an offer to sell a real property, an offer to lease a real property, or the like. Accordingly, a descriptor for that primary ad may describe a characteristic of the real property. Suitable descriptors for such a primary ad may include an SIC code (Standard Industrial Classification code) or data corresponding to price, rental rate, address, acreage, square footage, architectural style, office count, bedroom count, bathroom count, number of floors, garage size, parking, roofing material, floor material, window covering, air conditioning, heating, basement, percent of finished space, landscape, inclusions, amenities, sewer connection, water connection, zoning, patio space, deck space, or the like.

In certain embodiments where the system includes primary ads comprising real estate listings, the display criterion for the various collateral ads may include an SIC code. For example, the display criterion for a particular collateral add may include an SIC code and a range of values. That range may correspond to price, rental rate, address, acreage, square footage, number of offices, number of bedrooms, number of bathrooms, number of floors, garage size, percent of finished space, percent of finished landscape, or the like.

The display criterion (or criteria) for a particular collateral may be selected by the collateral advertiser posting that ad to the system. Accordingly, the system may grant advertisers the opportunity to define their ideal consumers. Accordingly, the leads produced by the system may be of higher quality and more significant value to the consumers and advertisers.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram illustrating one embodiment of a computer network suitable for implementing a system in accordance with the present invention;

FIG. 2 is a schematic block diagram illustrating one embodiment of a system in accordance with the present invention interacting with consumers, a site owner, and advertisers;

FIG. 3 is a schematic block diagram illustrating one embodiment of a site server interacting with a database in accordance with the present invention;

FIG. 4 is a schematic block diagram illustrating further interaction between the site server and database illustrated in FIG. 3;

FIG. 5 is a schematic block diagram illustrating one embodiment of a database in accordance with the present invention;

FIG. 6 is a schematic block diagram illustrating one embodiment of a method for operating a system in accordance with the present invention;

FIG. 7 is a schematic block diagram illustrating one embodiment of a method of identifying and prioritizing the collateral ads to be displayed with a primary ad in accordance with the present invention;

FIG. 8 is a schematic block diagram illustrating one embodiment of a two-dimensional priority matrix ranking collateral ads for display in accordance with the present invention;

FIG. 9 is a schematic block diagram illustrating one embodiment of a cost per click breakdown in accordance with the present invention;

FIG. 10 is a schematic block diagram illustrating one embodiment of a method for implementing various user-side and advertiser-side protocols after selection of a collateral ad in accordance with the present invention;

FIG. 11 is a schematic block diagram illustrating is one embodiment of a method providing a consumer with useful functionality, while simultaneously growing the number of advertisers using a system in accordance with the present invention;

FIG. 12 is a schematic block diagram illustrating one embodiment of a display template presenting a consumer with search options in accordance with the present invention;

FIG. 13 is a schematic block diagram illustrating one embodiment of a display template presenting a primary ad with multiple, relevant collateral ads;

FIG. 14 is a schematic block diagram illustrating one embodiment of a display template presenting a primary ad comprising a real estate listing with multiple, relevant collateral ads;

FIG. 15 is a schematic block diagram illustrating one embodiment of a lead that may be passed to an agent in accordance with the present invention;

FIG. 16 is a schematic block diagram illustrating one embodiment of an agent-side template for an instant messaging utility supported by a system in accordance with the present invention; and

FIG. 17 is a schematic block diagram illustrating one embodiment of a consumer-side template for an instant messaging utility supported by a system in accordance with the present invention.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

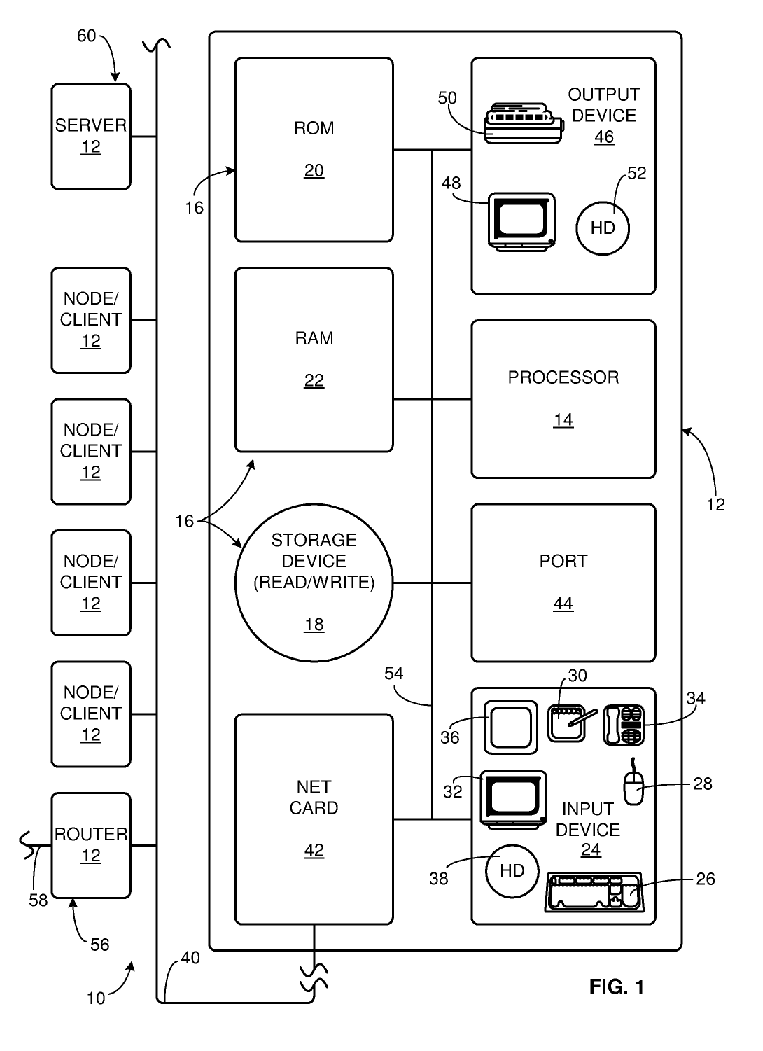

Referring to FIG. 1, an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments. For example, a keyboard 26 may be used for interaction with the user, as may a mouse 28 or stylus pad 30. A touch screen 32, a telephone 34, or simply a telecommunications line 34, may be used for communication with other devices, with a user, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12 may have various communication capabilities. In certain embodiments, a minimum of logical capability may be available in any node 12. For example, each node 12 may contain a processor 14 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

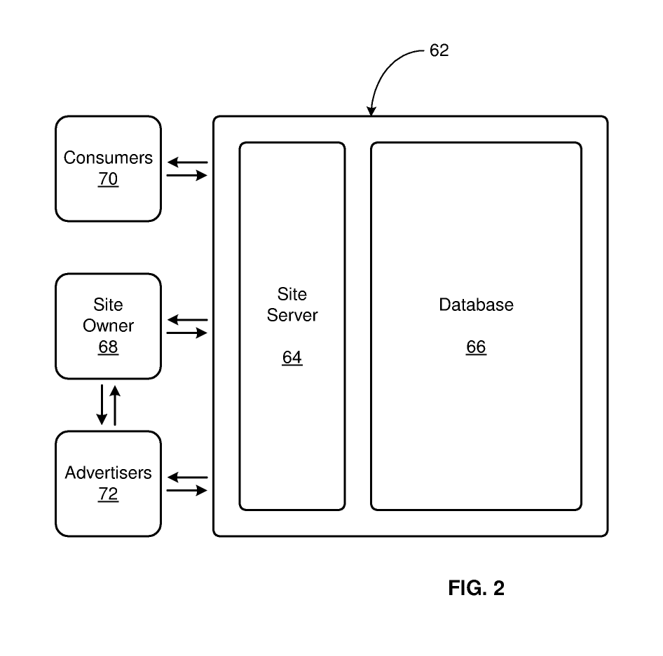

Referring to FIG. 2, an apparatus 10 may support a system 62 in accordance with the present invention. In selected embodiments, such a system 62 may include a site server 64 and a database 66. A site server 64 may comprise software running on one or more machines 12 to serve content (e.g., HTTP content) to web browsers on client machines 12. A database 66 may be a collection of information stored by one or more nodes 12 or clients 12 in a systematic way. The database 66 may be organized such that a computer program (e.g., site server 64) may consult it to answer questions.

A site owner 68 or site manager 68 may use a system 62 in accordance with the present invention to provide content stored in the database 66 to various consumers 70. In general, the content may be information of worth to, or sought by, the consumers 70. Accordingly, the consumers 70 may be motivated to use the system 62 and access the content. By attracting consumers 70, a site owner 68 may also attract advertisers 72. That is, the system 62 may provide a medium for advertisers to sort, select, and reach the consumers 70. Accordingly, in selected embodiments, advertisers 72 may compensate a site owner 68 for advertising exposure. The amount of that compensation may vary widely depending on the value provided by the site owner 68 to the advertiser.

As a general matter, an advertiser 72 may be willing to provide greater compensation for greater exposure or a greater number of contacts. While it is not necessarily greater exposure that an advertiser 72 seeks, the advertiser 72 may believe that greater exposure will increase sales. It may be that, for every one hundred randomly selected people contacted by an advertiser 72, five sales may typically be secured. Accordingly, by doubling the number of people contacted, an advertiser 72 may hope to double the sales secured.

Furthermore, as a general matter, an advertiser 72 may be willing to provide greater compensation for higher quality exposure or contacts. For example, it may be that at any given time fifteen out of every one hundred randomly selected people are interested in purchasing a new car. However, it may also be, for example, that at any given time forty out of every one hundred people who graduated from college within the last month are interested in purchasing a new car. Accordingly, a seller (advertiser 72) of new cars may be willing to pay more for exposure to recent graduates of college than for exposure to some less interested demographic. Thus, to maximize advertising revenue, a site owner 68 may seek to increase the exposure as well as the quality of the exposure.

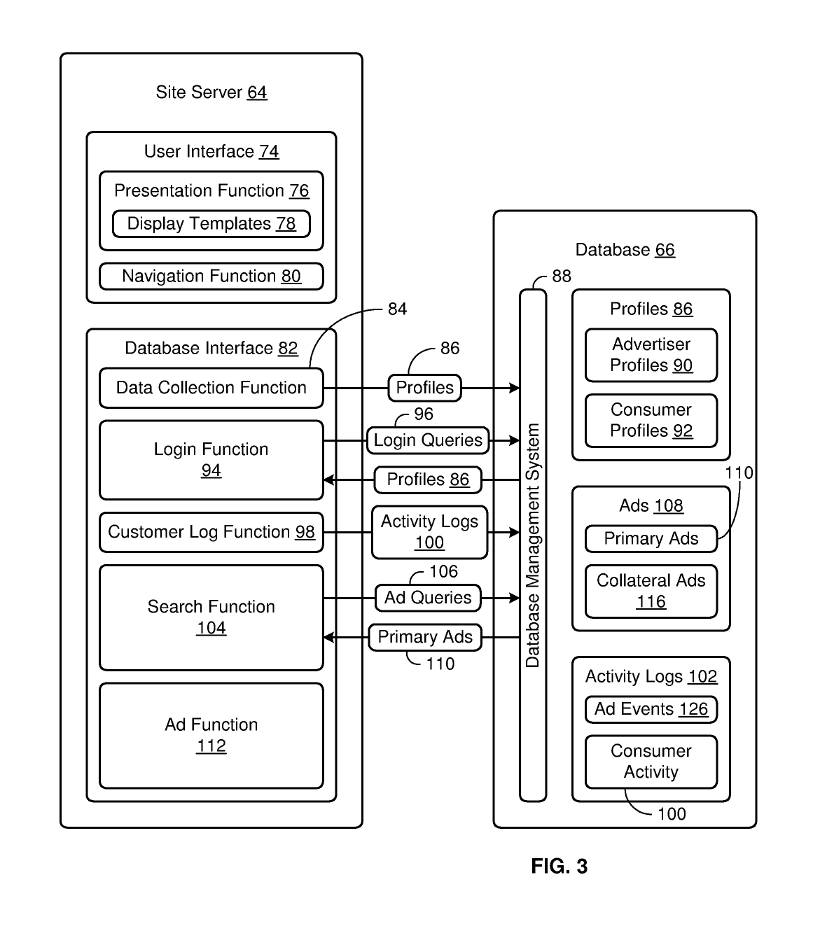

Referring to FIG. 3, in selected embodiments, a system 62 in accordance with the present invention may include a site server 64 supporting a website. In general, a website may comprise one or more files or “pages” stored on one or more nodes 12 that can be accessed via a network 40 such as the Internet. Typically, a website includes a “home page,” the first page a consumer 70 is likely to encounter upon accessing the website. The homepage may inform the consumer 70 of the contents of the website. The files of a website may contain textual or graphical “links” that can be selected in order to move to other files or pages within or without the website or at least the user's browser window.

In selected embodiments, a site server 64 may include a user interface 74. A user interface 74 may coordinate interaction between the system 62 and the users 68, 70, 72 of the system 62. For example, the user interface 64 may include a presentation function 76 controlling the content and content format to be displayed by the site server 64. Accordingly, in certain embodiments, a presentation function 76 may include one or more display templates 78 defining the visual look supported by the site server 64 (e.g., the look of the various pages of a website supported by the site server 64). Also, a user interface 74 may include a navigation function 80. The navigation function 80 may receive commands from a user 68, 70, 72 through the network 40 and direct the presentation function 76 to display other templates, files, pages, and the like.

A site server 64 may also include a database interface 82. A database interface 82 in accordance with the present invention may facilitate communication (e.g., queries and responses) between a site server 64 and a database 66. For example, a site server 64 may receive data from a consumer 70 through the user interface 74. This data may be compiled or collected by a data collection function 84 of the database interface 82 and assembled into profiles 86, which may be passed to a database management system 88 for storage within the database 66.

A database 66 may store various types of profiles 86. For example, a database 66 may store one or more advertiser profiles 90. An advertiser profile 90 may provide information regarding an advertiser 72 doing business on the system 62. Similarly, a profile 86 may be associated with a consumer 70. Accordingly, consumer profiles 92 may also be stored within a database 66.

In selected embodiments, a database interface 82 may include a login function 96. A login function 96 may control access to various pages or files of a website. For example, a user 68, 70, 72 may only be granted permission to view certain pages after having created an account (e.g., using a data collection function 84) and then logging onto that account using the login function 94. Account or login information may be stored as part of a profile 86 corresponding to that user 70, 72. Accordingly, when returning to the system 62, the user 70, 72 may enter the login information. This login information may be compiled or collected by the login function 94 and then passed as a login query 96 to the database 66.

The database 66 may reply to such queries 96 with one or more profiles 86 corresponding thereto. Upon receipt of the profile 86 or profiles 86, the login function 94 may grant the particular user 70, 72 access rights associated with the particular profile 86 or profiles 86. Alternatively, if the database 66 does not recognize or find any record relating to a particular login query 96, the database 66 may so inform the login function 94. Accordingly, the login function 94 may continue to deny the user 70, 72 access to selected content until correct login information is collected.

In certain embodiments, a database interface 82 may include a consumer log function 98. A consumer log function 98 may track the activities of a consumer 70 with respect to the site server 64. For example, a consumer log function 98 may record the nature of the material searched, viewed, selected, or the like by the consumer 70. Additionally, the consumer log function 98 may record the time the consumer 70 spends with particular material. All such information may compiled by a consumer log function 98 to form a consumer activity log 100. Such logs 100 may be passed to the database 66 for storage. In selected embodiments, a database 66 may store various types or kinds of activity logs 102.

A database interface 82 in accordance with the present invention may also include a search function 104. A search function 104 may assist in retrieving material from a database 66. For example, a search function 104 may work with a database management system 88 to ensure that proper queries 106 are passed from the site server 64 to the database 66. In selected embodiments, a search function 104 may simply “palletize” (e.g. prepare, package, or support, etc.) a query 106 and send it to a database management system 88, which may in turn perform the actual searching and retrieving from the records of the database 66. In such embodiments, the database management system 88 may then return the identified records to the search function 104 for use by the site server 64.

In general, a search function 104 may be configured to retrieve from a database 66 the content or material sought by the searching entity 70, 72. For example, a search function 104 may retrieve the content desired by a consumer 70 accessing the system 62. The nature of the content may depend on the nature of the system 62. Accordingly, the nature of the content may vary widely.

Electronic commerce (eCommerce) comprises buying and selling products or services over electronic systems such as the Internet 40 and other computer networks 40. Since the introduction of the Internet, the amount of eCommerce has grown dramatically. Currently, a significant percentage of commercial transactions are completed using eCommerce systems. Moreover, a significant percentage of commercial transactions completed outside of eCommerce systems began with research conducted using eCommerce systems. Accordingly, while a consumer 70 may ultimately buy an automobile in person at a “brick-and-mortar” establishment, that consumer 70 will have likely spend hours researching various automobiles over the Internet.

In view of the importance of eCommerce systems in the marketplace, consumers 70 are currently desirous to access systems engaging in that segment of the market. Accordingly, in selected embodiments, the content attracting consumers 70 to a system 62 in accordance with the present invention may be one or more ads 108 inviting consumers 70 to engage in commercial transactions.

For example, the ads 108 may be automobile listings, real estate listings, personal property listings, or the like, offering for sale various goods and services. Ads 108 that are primarily sought by a consumer 70 may be considered primary ads 110. Thus, in certain embodiments, a query 106 created by a consumer 70, collected by a search function 104, and submitted to a database 66 may actually be an ad query 106. Also, the responses generated by a database 66 to such queries 106 may include one or more primary ads 110. The user interface 74 may then systematically present the primary ads 110 to the consumer 70 for browsing.

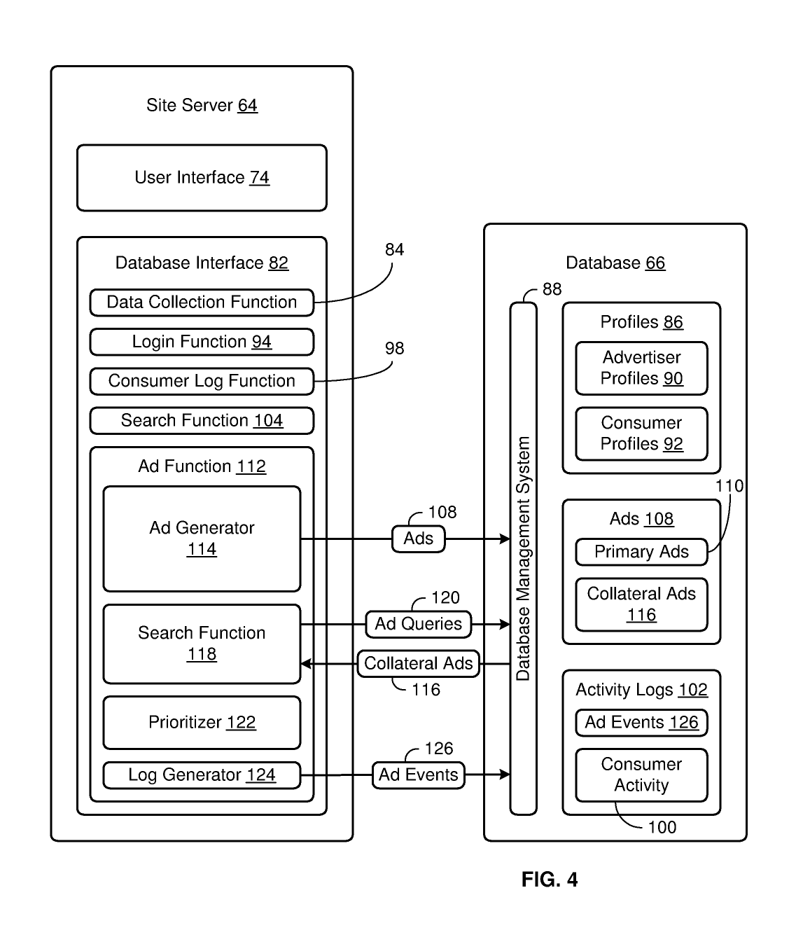

Referring to FIG. 4, in selected embodiments, a site server 64 in accordance with the present invention may include an ad function 112. In selected embodiments, an ad function 112 may include an ad generator 114. An ad generator 114 may aid an advertiser 72 in creating and storing an ad 108 within the database 66. Accordingly, an ad generator 114 may prompt an advertiser 72 for the textual, image, or other data necessary to generate or complete an ad 108. In selected embodiments, the ads 108 stored within a database 66 may be both primary ads 110 and collateral ads 116.

In one embodiment, an ad generator 114 in accordance with the present invention may prompt a collateral advertiser 72 to enter an SIC code. Alternatively, the ad generator 114 may receive a description of the nature of the business in which the collateral advertiser 72 is engaged. An ad generator 114 may prompt a collateral advertiser 72 to make various selections with respect to format, text, logo inclusion, and the like. An ad generator 114 may prompt a collateral advertiser 72 to input or select various display criteria. An ad generator 114 may also prompt a collateral advertiser 72 to make font selections or to request a specialized or custom font be created by the site owner 68. An ad generator 114 may also prompt a collateral advertiser 72 to make selections with respect to various convenience features with respect to notification of selection by a consumer or the like.

While primary ads 110 may be those directly sought by a consumer 70, collateral ads 116 may be those related thereto, but only indirectly sought by a user typically at another time. For example, a consumer 70 may use a system 62 in accordance with the present invention to search for an antique or classic car for purchase. Accordingly, the primary ads 110 retrieved and displayed for the consumer 70 may be antique or classic cars. However, certain antique or classic cars are in need of restorative services or parts. Collateral ads 116 may be those advertising restorative services, hard to find automobile parts, or the like.

In general, advertisers 72 using a system 62 in accordance with the present invention may be divided into two groups, namely those providing primary ads 110 (i.e., primary advertisers 72) and those providing collateral ads 116 (i.e., collateral advertisers 72). A system 62 may treat the two groups of advertisers 72 differently. For example, to attract consumers 70, the system 62 may require primary ads 110. In general, the greater the number of primary ads 110, the greater the number of consumers 70 who will be drawn to the system 62, confident that they will there find what they are seeking. Accordingly, in selected embodiments, a system 62 may minimize the obstacles preventing primary advertisers 72 from posting a primary ad 110 on the system 62.

For example, in embodiments where the primary ads 110 are real estate listings, the primary advertisers 72 are likely to be real estate agents 72 and agencies 72. In general, such advertisers 72 are highly motivated to present their listings to as many consumers 70 as possible. Obstacles that may prevent primary advertisers 72 from posting ads 110 on a system 62 in accordance with the present invention may include the cost of the posting, amount of time required to effect the posting, obstacles preventing a consumer 70 from accessing the posting, and the like.

Accordingly, in selected embodiments, a system 62 may present an efficient and user friendly method of posting primary ads 110 at little or no cost to the primary advertiser 72. Similarly, a system 62 may minimize the obstacles preventing consumers 70 from accessing the primary ads 110. In such a system 62, the benefits for posting primary ads 110 may significantly outweigh the costs. The result may be significant numbers of primary ads 110 being posted and a significant number of consumers 70 accessing the system 62 to search through those primary ads 110. Quantities may tend to be maximized, but a lack of filtering and sorting may tend toward lower quality of “connections.”

With the traffic of consumers 70 interested in and searching the primary ads 110, collateral advertisers 72 seeking access to those consumers 70 may be attracted to the system 62. Knowing that access to the consumers 70 may result in sales for themselves, the collateral advertisers 72 may be motivated to compensate the site owner 68 for that access. Moreover, the compensation the collateral advertisers 72 are willing to pay may increase with the number of contacts and the quality of the contacts.

In selected embodiments, an ad function 112 may be configured to increase the quality of the contacts made between collateral advertisers 72 and consumers 70. This may be done by focusing or refining the various qualifications of consumers 70 to whom the various collateral ads 116 are presented. In certain embodiments, the focusing or refining may be based on an examination of the primary ads 110 being searched, viewed, or selected by a particular consumer 70.

For example, suppose a consumer 70 has selected and is viewing a primary ad 110 advertising a 1965 Ford Mustang. An ad function 112 may therefore simultaneously display with the primary ad 110 one or more collateral ads 116 meeting the likely needs of consumers 70 purchasing a 1965 Ford Mustang. Such collateral ads 116 may include ads for restorative services, upholstery repair services, finish re-conditioners, rust repair kits, car parts dealers, engine re-builders, classic car clubs, classic car events, and the like. Accordingly, without requiring a consumer 70 to enter any personal information, relevant collateral ads 116 may be presented.

When more information is known about a particular consumer 70, the collateral ads 116 may be further tailored to the consumer 70. Suppose that as part of an account creation process, a data collection function collected a residential ZIP code (or equivalent) from a particular consumer 70. A ZIP code or Zone Improvement Plan code is a numerical code assigned by the U.S. Postal Service to designate a local area or entity for the delivery of mail. A ZIP code may consist of five, seven, nine, or eleven digits, and may refer to a street section, a collection of streets, an establishment, a structure, or a group of post office boxes.

Once collected, a ZIP code may be stored within a database 66 as part of a user profile 92. Accordingly, when that consumer 70 logs into a system 62 and selects and views a primary ad 110 for a 1965 Ford Mustang, the system 62 may simultaneous display with the primary ad 110 even more relevant collateral ads 116. For example, the system 62 may display only restorative services, engine re-builders, and the like pertaining to advertisers 72 located within a certain distance of the ZIP code of the consumer 70.

Accordingly, should the consumer 70 select the collateral ad 116 for the restorative services, the collateral advertiser 72 will have made a significantly more valuable contact (i.e., a contact more likely to complete a sale), namely, a person interested in a 1965 Ford Mustang, interested in restorative services, and located within a reasonable distance of the place of business of the collateral advertiser 72. In view of the greater value provided to the collateral advertiser 72, the site owner 68 may require greater compensation for the contact or lead.

In selected embodiments, an ad function 112 may include a search function 118. A search function 118 may retrieve from the database 66 collateral ads 116 relevant to the primary ads 110 being displayed. In certain embodiments, a search function 118 may simply palletize a query 120 and send it to a database management system 88, which may in turn perform the actual searching and retrieving from the collateral ads 116 of the database 66. In such embodiments, the database management system 88 may then return the identified collateral ads 116 to the search function 118 for use by the site server 64.

In certain embodiments, upon receipt of a query from a consumer 70, a search function 104 may identify primary ads 110 within the database 66 relevant to the consumer 70. Another search function 118, which may be a separate embodiment or merely a subsequent operation of the first search function 104, may simultaneously locate collateral ads 116 relevant to the primary ads 110. Accordingly, a search function 118 may examine a primary ad 110 to be displayed and create an ad query 120 directed to the database 66. In response to the ad query 120, the database 66 may return all relevant collateral ads 116.

An ad function 112 may include a priority module 122 or sorter 122, a “prioritizer” 122 determining which collateral ads 116 are displayed in proximity or in conjunction with which primary ads 110. A prioritizer 122 may also determine when a collateral ad 116 that has been displayed should be removed and replaced with a new collateral ad 116.

In selected embodiments, an ad function 112 may include a log generator 124. A log generator 124 may track or record which collateral ads 116 have been displayed to a particular consumer 70. These records may be stored as an ad event 126. A log generator 124 may pass ad events 126 to a database 66 for storage. Accordingly, a database 66 in accordance with the present invention may store various records 102 reflecting the activities of a system 62, include both ad events 126 and consumer activities 100.

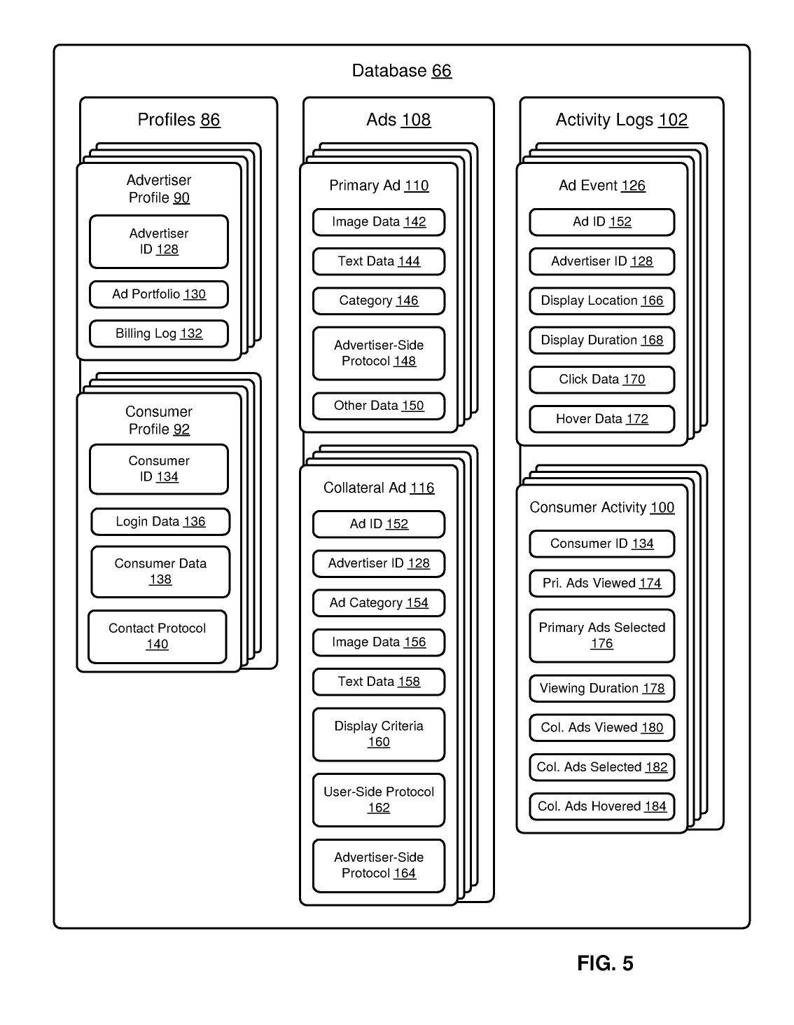

Referring to FIG. 5, a database 66 in accordance with the present invention may store various records including profiles 86, ads 108, activity logs 102, and the like. In selected embodiments, the profiles 86 stored by a database 66 may include one or more advertiser profiles 90 and one or more consumer profiles 92. In selected embodiments, an advertiser profile 90 may include an advertiser identification 128 identifying the relevant advertiser 72. An advertiser profile 90 may also include an ad portfolio 130 comprising a list of the various ads 108 pertaining to the particular advertiser 72. An advertiser profile 90 may also include a billing log 132 recording the activities (e.g., ad 108 selections or the like) for which the site owner 68 may charge the advertiser 72.

A consumer profile 92 in accordance with the present invention may include a consumer identification 134 A consumer identification 134 may be a unique character string identifying a particular consumer 70. A consumer profile 92 may also include login data 136. This data 136 may include passwords, usernames, or the like enabling a site server 64 to identify a particular consumer 70. A consumer profile 92 may also include other consumer data 138. For example, during use of a system 62 in accordance with the present invention a consumer 70 may input certain personal information. This personal information may be stored as part of the consumer data 138.

In selected embodiments a consumer profile 92 may include a contact protocol 140. A contact protocol 140 may describe the criteria and manner for contacting a consumer 70. For example, a contact protocol 140 may set forth criteria for primary ads 110 of interest to the consumer 70. Accordingly, when new primary ads 110 are added to a database 66 that satisfy the criteria, the system 62 may so notify the consumer 70 in the manner set forth in the contact protocol 140. For example, the consumer 70 may specify that links to the new primary ads 110 be provide via email.

The ads 108 stored within a database 66 may include primary ads 110 and collateral ads 116. A primary ad 110 may include the digital information required to access, generate, or display the ad 110 to a consumer 70 via the computer network 40. Accordingly, a primary ad 110 may include image data 142, text data 144, or the like.

In certain embodiments, a primary ad 110 may also include a category 146. The category 146 may differentiate one type of primary ad 110 from another 110. For example, in systems 62 where the primary ads 110 include real estate listings, the category 146 may be the type of real estate being advertised. For example, the category 146 may be residential properties for sale, residential property for lease, commercial office space for lease, land for new construction, etc. Accordingly, the category 146 may be a designation facilitating search or retrieval of primary ads 110 from the database 66.

In selected embodiments, a primary ad 110 may include an advertiser-side protocol 148. An advertiser-side protocol 148 may include instructions with respect to contacting an advertiser 72 regarding activity on the primary ad 110. A primary ad 110 may also include other data 150 as desired or necessary. For example, a primary ad 110 may include an advertiser identification 128 connecting the primary ad 110 to the appropriate advertiser 72.

Other data 150 stored in association with a primary ad 110 may be descriptor information. In selected embodiments, a descriptor may be a characteristic or characterization of the goods and services being advertised by the primary ad 110. For example, for a primary ad 110 comprising an automobile listing, descriptors may include data reflecting price, year of manufacture, make, model, mileage, tire condition, body condition, repairs needed, etc.

Similarly, for a primary ad 110 comprising a real estate listing, descriptors may include data relating to price, rental rate, address, acreage, square footage, architectural style, year constructed, number of offices, number of bedrooms, number of bathrooms, number of floors, garage size, parking, roofing material, age of roof, floor material, window coverings, air conditioning, heating, basement, percent of finished space, landscape, inclusions, amenities, sewer, water, zoning, patios, decks, and the like.

In selected embodiments, when a site server 64 (e.g., ad generator 114) creates a primary ad 110, the system 62 may prompt the primary advertiser 72 to input specific information with respect to various characteristics of the goods and services being advertised thereby. The nature of those prompts may vary depending on the nature of the primary ads 110 used by the particular system 62. For example, a system 62 may prompt an advertiser 72 interested in selling a home to answer “yes” or “no” as to whether the home includes air conditioning, a water softener, planted grass, etc. Accordingly, a system 62 may extract descriptors from an advertiser 72.

In certain embodiments, a system 64 (e.g., ad generator 114) may assign one or more SIC codes to a primary ad 110. An SIC code or Standard Industrial Classification code is a four digit number developed by the U.S. Office of Management and Budget to identify industrial sectors. Within that classification system, the first two digits in the code identify a broad industrial sector or major group. For example, “07” corresponds to the major group identified as “agricultural services.” Adding another digit to the first two digits identifies the industry group. For example, “078” identifies “landscape and horticultural services.” Adding the forth and final digit provides the most specific grouping. For example, “0782” is the SIC code for “lawn and garden services” and is applied to businesses that offer lawn seeding services, sod laying services, and the like.

A primary ad 110 may be assigned, or tagged with, an SIC code based on the answers received by the system 62 in response to one or more prompts made while a primary ad 110 was being generated. For example, if an advertiser 72 answers “no” to a prompt regarding whether the home to be advertised includes planted grass, the system 62 may assign the SIC code “0782,” indicating that a buyer of the home may potentially need “lawn and garden services.” Similarly, if an advertiser 72 answers “no” to a prompt regarding whether the home to be advertised includes air conditioning, the system may assign the SIC code “1711,” indicating that a buyer of the home may potentially need “plumbing, heating and air conditioning” services.

Accordingly, a system 62 may be programmed to automatically assign SIC codes based on the answers to the prompts the system 62 will present during the ad generation process. Once assigned to a primary ad 110, a SIC code may be considered to be a descriptor and may be stored as data 150 associated with that primary ad 110.

A collateral ad 116 in accordance with the present invention may include an ad identification 152. The ad identification 152 may facilitate tracking or billing with respect to that particular ad 116. A collateral ad 116 may also include an advertiser identification 128 identifying the advertiser 72 associated therewith. Accordingly, using the ad identification 152, the advertiser identification 128, or some combination thereof, the system 62 may properly bill a collateral advertiser 72 when a collateral ad 116 pertaining thereto is selected or “clicked” by a consumer 70.

In selected embodiments, a collateral ad 116 may include an ad category 154. In selected embodiments, this ad category 154 may be similar to the category 146 of the primary ads 110. For example, the ad category 154 may specify the primary ads 110 or categories 146 of primary ads 110 with which the collateral ad 116 may be displayed. A collateral ad 116 may include digital information required to generate or display the ad 116 to a consumer 70 via the computer network 40. Accordingly, a collateral ad 116 may include image data 156, text data 158, or the like.

A collateral ad 116 may also include display criteria 160. In selected embodiments, the display criterion 160 or multiple criteria 160 may describe the situational characteristics where a collateral advertiser 72 seeks display of the ad 116. Accordingly, the display criteria 160 of the present invention provide a collateral advertiser 72 the opportunity to define its ideal consumer 70 and display its ads 116 only to that ideal consumer 70. As a result, “clicks” or selections by that ideal consumer 70 are worth more to the advertiser 72 as they will likely provide a higher rate of conversion to sales.

In some embodiments, the display criteria 160 may set forth the characteristics of a primary ad 110. For example, the display criteria 160 may set forth particular descriptors that must be present in a primary ad 110 before the collateral ad 116 is displayed therewith. In other embodiments, the display criteria 160 may set forth particular characteristics of a consumer 70 that must be met before the collateral ad 116 is displayed thereto. For example, the display criteria 160 may set forth a range of ZIP codes and limit display of the collateral ad 116 to consumers 70 residing within a ZIP code within the range.

In still other embodiments, the display criteria 160 may set forth required characteristics for both the primary ad 110 and the consumer 70. For example, display criteria 160 may limit display of a collateral ad 116 to situations where the primary ad 110 is for a home priced between $500,000 and $750,000 and the viewing consumer 70 lives in a particular area.

In selected embodiments, display criteria 160 may include one or more SIC codes. For example, a collateral ad 116 posted by a sod layer 72 may include the SIC code “0782” within its display criteria. Accordingly, the collateral ad 116 will only be displayed with primary ads 110 including the SIC code “0782” as a descriptor. Using the example set forth hereinabove wherein the SIC code “0782” is applied to primary ads 110 advertising homes that do not include planted grass, the collateral ad 116 of the sod layer 72 may focus on consumers 70 likely to need sod-laying service in the near future.

Adding additional limitations may further direct the collateral ads 116 to the consumers 70 likely to be the most receptive thereto. Continuing with the example from above, it may be possible that the sod layer 72 also provides hydro-seeding services. Moreover, it may be possible that new homeowners with newly constructed homes purchased for less than $200,000 more often select hydro-seeding as the method to plant the yard, while those purchasing newly constructed home for over $500,000 more often select sod laying as the method to plant a yard. Accordingly, the sod layer 72 may post multiple collateral ads 116 on a real estate system 62 in accordance with the present invention.

The first ad 116 may advertise hydro-seeding services and may include within its display criteria 160 an SIC code of “0782,” an asking price in the range of $100,000 and $225,000, and a range of ZIP codes corresponding to the address of the advertised home. The second ad 116 may advertise sod laying services and may include within its display criteria 160 an SIC code of “0782,” an asking price in the range of $500,000 or above, and a range of ZIP codes corresponding to the address of the advertised home. Accordingly, a system 62 in accordance with the present invention provides the sod layer 72 the ability to focus its advertising effort on consumers 70 most likely to complete a sale for a particular good or service.

A collateral ad 116 may include a consumer-side protocol 162. The consumer-side protocol 162 may define what the collateral advertiser 72 desires the selection of an ad 116 to do, viewed from the perspective of the consumer 70. For example, a suitable consumer-side protocol 162 may be such that when a collateral ad 116 is selected by a consumer 70, a new browser window is launched directed the consumer 70 to the website of the advertiser 72. In selected embodiments, a collateral ad 116 may also include an advertiser-side protocol 164. An advertiser-side protocol 164 may define how the advertiser 72 desires to proceed once a collateral ad 116 has been selected.

A database 66 in accordance with the present invention may store one or more activity logs 102. In selected embodiments, the activity logs 102 stored within a database 66 may include ad events 126 and consumer activities 100. In selected embodiments, an ad event 126 may include an ad identification 152 identifying the ad 108 displayed. An ad event 126 may also include an advertiser identification 128 identifying the corresponding advertiser 72. The ad event 126 may also include a display location 166 setting forth the location within the display format where the ad 108 was displayed. Similarly an ad event 126 may store a display duration 168 indicating the amount time the ad 108 was displayed to a consumer 70.

In selected embodiments, an ad event 126 may include click data 170 identifying the number of times it was selected, the identification of consumers 70 who made the selection, and the like for a particular ad 108. Also, an ad event 126 may include hover data 172 characterizing the movement of a pointing device (e.g., mouse) or the attention given by a consumer 70 to a particular ad. That is, when viewing or reading an ad 108, a consumer 70 may tend to place a pointer over or near the ad 108. Accordingly, hover data 172 may give an advertiser 72 greater information regarding the interest of a consumer 70 in a particular ad 108.

Ad events 126 may provide a research tool for advertisers 72. For example, a database 66 in accordance with the present invention may be queried to generate various reports characterizing or reporting on one or more ad events 126. A primary advertiser 72 may use the ad event 126 information stored within a database 66 to refine its primary ads 110. Similarly, a collateral advertiser 72 may use the ad event 126 information stored within a database 66 to refine its understanding of who really is its ideal consumer 70. Accordingly, a collateral advertiser 72 may shift or rework its display criterial 160 to more accurately reflect actual conduct patterns of consumers 70.

A consumer activity log 100 may include consumer identification information 134. The consumer identification 134 may correspond to a particular consumer profile 92 thereby identifying a particular consumer 70. A consumer activity log 100 may also include a listing of the content viewed 174 by a consumer 70, as well as a listing of the content selected 176 by the consumer 70. Other information stored within a consumer activity log 100 may include viewing duration 178, ads 108 viewed 180, ads 108 selected 182, and ads 108 hovered 184. Such information may characterize the browsing habits or interests of a particular consumer 70.

In selected embodiments, one or more activity logs 102 may form the basis of display criteria 160. For example, the display criteria 160 may specify that the corresponding collateral ad 116 only be displayed to consumers 70 having viewed at least three primary ads 110 having a particular characteristic. Accordingly, one or more consumer activity logs 100 pertaining to a particular consumer 70 may be consulted or queried to determine whether the collateral ad 116 may be displayed to that consumer 70.

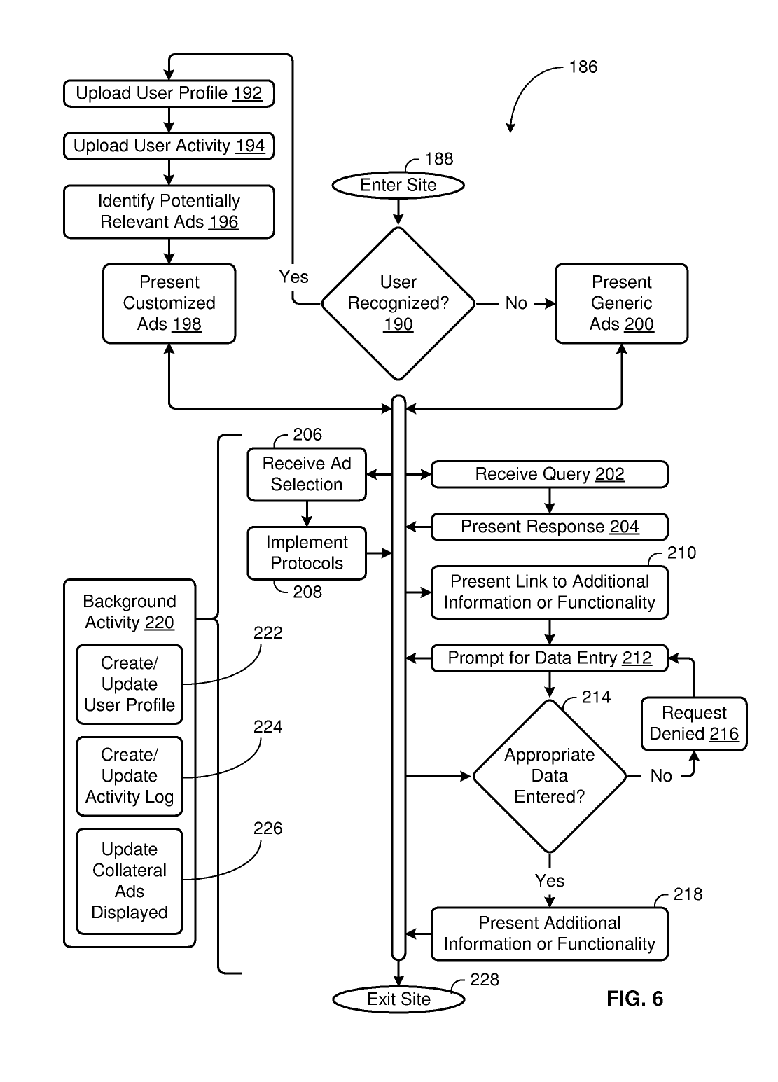

Referring to FIG. 6, the interaction 186 between a consumer 70 and a system 62 in accordance with the present invention may begin when the consumer 70 enters 188 a site (e.g., website) supported by the system 62. The system 62 may then determine 190 whether it recognizes the particular consumer 70. This may be done in any suitable manner. For example, in a previous visit to the site, a “cookie” may have been place on the computer 12 of the consumer 70. Accordingly, the system 62 may search the computer 12 for a cookie. Alternatively, during a previous visit to the site, the consumer 70 may have created an account on the system 62. Thus, when the consumer 70 returns to the site and logs in, the consumer 70 may be recognized.

If the consumer 70 is recognized, the system 62 may proceed to upload 192, access 192, or identify 192 the consumer profile 92 corresponding to the consumer 70. The system 62 may also upload 194, access 194, or identify 194 one or more consumer activity logs 100 corresponding to the consumer 70. With such background information, a system 62 in accordance with the present invention may identify 196 and present 198 relevant or customized ads 108 to the consumer 70. For example, the system 62 may present to the consumer 70 the last primary ad 110 he or she viewed, with corresponding collateral ads 116.

Alternatively, if the consumer 70 is not recognized, the system 62 may simply present 200 a homepage, generic ads 108, or some combination thereof to the consumer 70. In selected embodiments, generic ads 108 may be collateral ads 116 having no display criteria 160 or very broad display criteria 160. Accordingly, they are ads 116 where the advertiser 72 has not chosen to specifically limit display to any particular audience.

Once the consumer 70 has entered 188 the site, the functionality provided by a system 62 in accordance with the present invention may depend on the selections of a consumer 70. For example, a system 62 may receive 202 a query comprising a search for certain primary ads 110. The system 62 may respond 204 by presenting the consumer 70 with all primary ads 110 satisfying the query. Accordingly, the consumer 70 may then browse the various primary ads 110.

At certain times, a system 62 may receive 206 from a consumer 70 an ad selection. For example, a system 62 may receive 206 a selection of a collateral ad 116. Accordingly, the system 62 may implement 208 the protocols 162, 164 associated with that collateral ad 116.

In selected embodiments, information corresponding to a consumer 70 may be desired for a system 62 to provide certain services to consumers 70 and advertisers 72. However, this desire for information regarding consumers 70 must be tempered by considerations of privacy. Moreover, consumers 70 are general disinterested in entering into a computer 12 significant amounts of personal information, particularly when they do not see the benefit they will receive in return.

Accordingly, a system 62 in accordance with the present invention may be configured to scale or stage the content or functionality provided to a consumer 70 according to the amount of information provided by the consumer 70 to the system 62. For example, a system 62 may offer a base level of functionality to all consumers 70, even those accessing the system 62 for the first time. The system 62 may, however, present 210 links to additional information or functionality. Should a consumer 70 select any such link, the system 62 may prompt 212 the consumer 70 for selected information. In general, the amount of information requested by be limited (e.g., not more than three pieces of information) and related as possible to the additional information or functionality requested. For example, a consumer 70 requesting notification from the system 62 when new primary ads 110 meeting a particular description are added may be required to create an account on the system 62 and provide an email address.

After prompting 212 a consumer 70 for the required information, the system 62 may then determine 214 whether the appropriate data is entered. If no data or improper data is entered, the request to see the additional information or experience the additional functionality may be denied 216. Alternatively, if appropriate data is entered, the additional information or functionality may be presented 218 to the consumer 70.

Meanwhile, as a consumer 70 navigates through a site supported by a system 62 in accordance with the present invention, the system 62 may perform various background activities 220. For example, as a consumer 70 navigates the site, the system 62 may create 222 or update 222 the profile 92 corresponding to the consumer 70, create 224 or update 224 various activity logs 102, and update 226 the collateral ads 116 displayed (e.g., change 226 the collateral ads 116 according to changes in the primary ads 110). Once the consumer 70 has finished navigating the site, the consumer 70 may exit 228 the site.

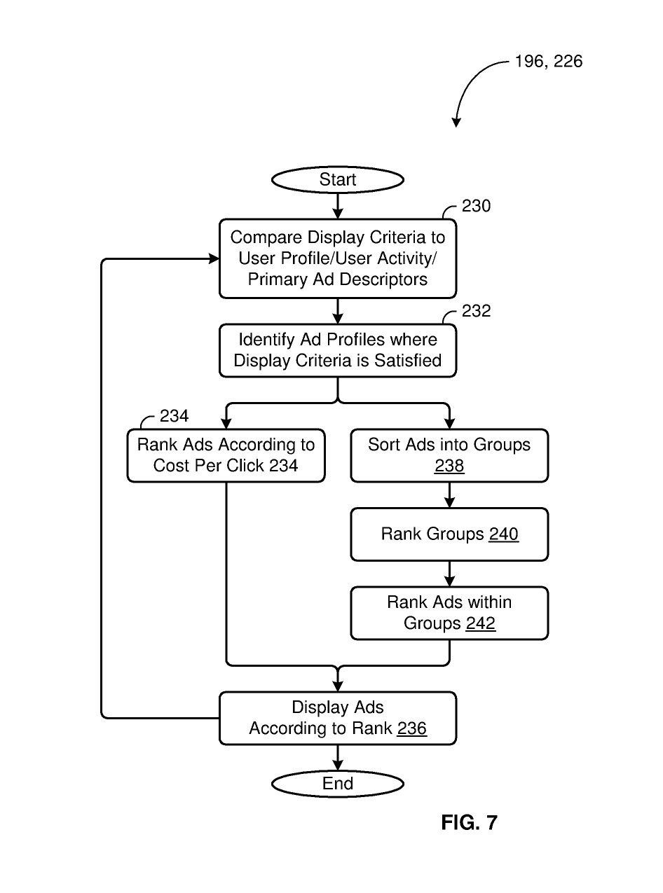

Referring to FIG. 7, the processes for identifying 196 potentially relevant collateral ads 116 and updating 226 or changing 226 the collateral ads 116 being displayed may be similar. In selected embodiments, the process 196, 226 may begin by comparing 230 a consumer profile 92 of the current consumer 70, one or more consumer activity logs 100 of the current consumer 70, descriptors of the primary ad 110, or some combination thereof, to the display criteria 160 of the various collateral ads 116 stored in the database 66. Accordingly, all collateral ads 116 whose display criteria 160 are satisfied by the consumer profile 92, activity logs 100, descriptors of the primary ad 110, or the like may be identified 232.

In one embodiment, the filters applied (e.g., sequentially) to determine which collateral ads 116 may be displayed may include an SIC code filter, primary ad descriptor filter, consumer browsing patterns filters, and previously viewed ads filter. An SIC code filter may filter out collateral ads 116 that do not have a matching SIC code. A primary ad filter may filter out collateral ads 116s having a display criteria 160 that is incompatible with the primary ad 110. A consumer browsing patterns filter may filter out collateral ads 116 having display criteria 160 that are incompatible with the averages of a consumer (e.g., display criteria 160 requires a 4,500 square foot average, but the average square footage of homes 110 viewed by the particular consumer 70 over the last month is only 3,650). A previously viewed ads filter may filter out collateral ads 116 previously selected or viewed by the particular consumer 70.

Once identified 232, the collateral ads 116 may be ranked. For example, a site supported by a system 62 in accordance with the present invention may only display a limited number of collateral ads 116 at any given time. There may be more collateral ads 116 identified 232 than can be display simultaneously. Accordingly, a determination must be made as to which collateral ads 116 will be displayed or displayed first.

In general, a site owner 68 may seek the greatest financial return for the ad space available. Accordingly, it may be in the best interest of the site owner 68 to display ads 116 providing the greatest potential return. For example, in selected embodiments, a system 62 in accordance with the present invention may employ a “pay-per-click” compensation arrangement for certain collateral ads 116. A site owner 68 may be compensated more for “clicks” by a consumer 70 of some collateral ads 116 more than others 116. Accordingly, a system 62 (e.g., prioritizer 122) may preferentially display collateral ads 116 having a higher return per click. For example, identified 232 collateral ads 116 may be individually ranked 234 accordingly to return per click. The collateral ads 116 having the greatest return per click may be displayed 236 first, followed by other collateral ads 116 in descending order of quality, ranking, etc.

In selected embodiments, a system 62 (e.g., prioritizer 112) may be programmed to drop a current collateral ad 116 and display the next collateral ad 116 when certain triggering events occur. A triggering event may be the passage of time, change of the primary ad 110, selection by a consumer 70, lack of interest by a consumer 70, or the like. For example, if a collateral ad 116 has been displayed for a certain period of time, and the consumer 70 has shown no interest in it, the ad 116 may be dropped in favor of the next collateral ad 116. Similarly, a change in the primary ad 110 may be a triggering event causing all identified 232 collateral ads 116 to be dropped in favor of a collateral ads 116 relevant to the new primary ad 110.

In selected embodiments, a triggering event may permanently drop a collateral ad 116. For example, once a collateral ad 116 has been selected by a consumer 70, it may not be displayed to that consumer 70 again. This preclusion may be desired or advocated by the site owner 68, the collateral advertiser 72, or both. From the perspective of the site owner 68, having selected a collateral ad 116 once, a consumer 70 may be less likely to do so again. Accordingly, the site owner 68 may prefer that other ads 116 be presented to maximize the return on advertisement space. From the perspective of the collateral advertiser 72, it may not want to pay again for a contact that has previously been made.

Alternatively, rather being individually ranked 234, the prioritization process of the identified 232 collateral ads 116 may begin by sorting 238 the ads 116 into various groups or categories. For example, in selected embodiments, the collateral ads 116 may include an SIC code identifying the nature of the goods or services being advertised. Accordingly, the identified 232 collateral ads 116 may be sorted 238 into groups by SIC code. Once sorted 238 into groups, the groups may be ranked 240, placing groups with a higher rate of return before those with a lower rate of return. The collateral ads 116 within each group may also be ranked 242. The collateral ads 116 may then be displayed 236 according to their respective ranks.

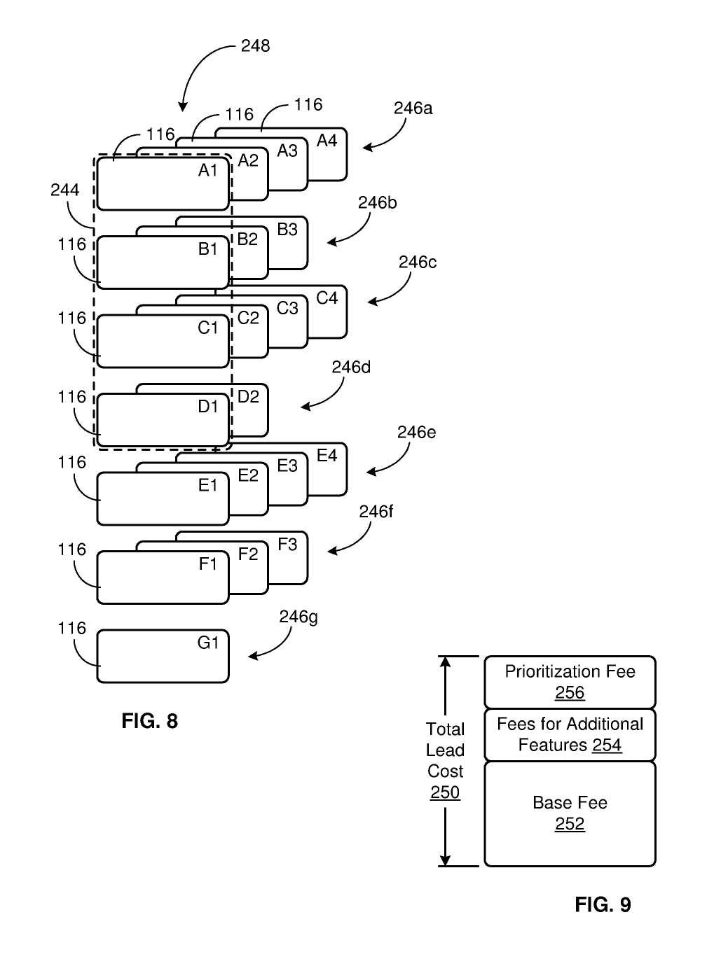

Referring to FIG. 8, for example, in one embodiment a system 62 may include a display space 244 accommodating four collateral ads 116. However, suppose twenty-one collateral ads 116 may be have been identified 232. Accordingly, the twenty-one collateral ads 116 may be sorted 238 into groups 246 (e.g., seven groups 246a, 246b, 246c, 246d, 246e, 246f, 246g sorted 238 by SIC code). The groups 246 may be ranked 240. The collateral ads 116 with the various groups 240 may also be ranked 242. The end result may be a two-dimensional priority matrix 248.

In such an embodiment, the highest ranked collateral ad 116 may be the highest ranked ad 116 in the highest ranked group 246a (i.e., the collateral ad 116 identified as “A1”). Conversely, the lowest ranked collateral ad 116 may be the lowest ranked ad 116 in the lowest ranked group 246g (i.e., the collateral ad 116 identified as “G1”). While this prioritization 248 may not display the highest return ads 116 (e.g., “A2” may have a higher rate of return than “B1”), it may be a suitable compromise between highest rate of return and diversity of ads 116.

For example, it may be that in a system 62 with primary ads 110 directed to real estate offerings, lender ads 116 may provide the greatest rate of return for the site owner 68. Accordingly, when the collateral ads 116 are sorted 238 and ranked 240 by group, the lender ads 116 may form the highest ranking group 246a. However, it may be undesirable to present a consumer 70 with an entire display space 244 filled with lender ads 116. A more diverse arrangement of collateral ads 116 may better suit (e.g., match) the interests and needs of the consumer 70. A two-dimensional priority matrix 248 in accordance with the present invention may provide that diversity, while still seeking to optimize the rate of return for the advertising space 244.

Triggering events may determine when one collateral ad 116 is dropped from the display space 244 and another 116 takes its place. For example, a consumer 70 may select the collateral ad 116 identified as “A1.” Accordingly, that collateral ad 116 may be dropped and the collateral ad 116 identified as “A2” may be advanced into the display space 244.

In selected embodiments, triggering events may drop an entire group 246. For example, the collateral ad 116 identified as “B1” may have been displayed for a selected period of time without receiving any interest from the consumer 70. Accordingly, “B1” may be dropped in favor of the collateral ad 116 identified as “B2.” If “B2” experiences the same disinterest from the consumer 70, the entire group 246b may be dropped form the display space 244. Thus, the display space 244 may accommodate a new group 246e.

Similarly, certain groups 246 may be dropped once all of the collateral ads 116 corresponding to that group 246 have been displayed. For example, the collateral ad 116 identified as “D1” may have been dropped from the display space 244 after it was selected by a consumer 70. Thereafter, the collateral ad 116 identified as “D2” may have been incorporated within the display space 244. When a triggering event results in “D2” being dropped, there may be no more collateral ads 116 within that group 246d. Accordingly, the group 246d may be dropped and another 246 may enter the display space 244. If all the relevant collateral ads 116 have been displayed or dropped, certain ads 116 that were previously dropped or displayed may be worked back into the display space 244.

In selected embodiments, there may be some continuity within a priority matrix 248, even with changes in the primary ad 110 being displayed. For example, a consumer 70 accessing the system 62 to search for a home is likely to view primary ads 110 offering homes in a similar price range and area. Accordingly, the collateral ads 116 pertaining to one primary ad 110 may also pertain to the next primary ad 110. In such situations, at the transition between primary ads 110, the collateral ads 116 or ad groups 246 that are no longer relevant may be dropped. However, those having display criteria 160 satisfied by the new primary ad 110 may remain and continue through the rotation. For example, if “A1” has been displayed with the first primary ad 110 and “A2” has been dropped for having display criteria 160 that is not satisfied by the new primary ad 110, then the collateral ad 116 identified as “A3” may be displayed with the new primary ad 110.

Referring to FIG. 9, a system 62 in accordance with the present invention may include or use any suitable compensation system. In selected embodiments, a system 62 may apply a “pay-per-click” compensation system to the collateral ads 116. The amount of the charge for each “click” may vary according to several factors. For example, in certain embodiments, the cost per click 250 may include a base fee 252, various additional fees 254, a prioritization fee 256, or some combination thereof.

A base fee 252 may be the fee charged for all collateral ads 116 within a particular group 246 or category 246. For example, a base fee 252 may be assigned for all collateral ads 116 corresponding to a particular SIC code and a particular geographic region. When ranking 240 one group 246 against another 246, the respective base prices 252 for the two groups 246 may be the deciding factor. (In certain embodiments, the ranking 242 of the collateral ads 116 within a particular group 246 may be according to cost per click 250.)

The total cost per click 250 may include fees 254 for one or more additional features. For example, an additional fee 254 may be applied to a collateral ad 116 where the advertiser 72 commissioned the site owner 68 to design and generate the collateral ad 116. Similarly, an additional fee 254 may be applied for special “a la carte” features or services requested by the advertiser 72.

In selected embodiments, the total cost per click 250 may include a prioritization fee 256. A prioritization fee 256 may be amount per click that an advertiser 72 is willing to pay to be ranked higher within a priority matrix 248. For example, a sufficiently large priority fee 256 may ensure that a particular collateral ad 116 will be ranked high within its corresponding group 246.

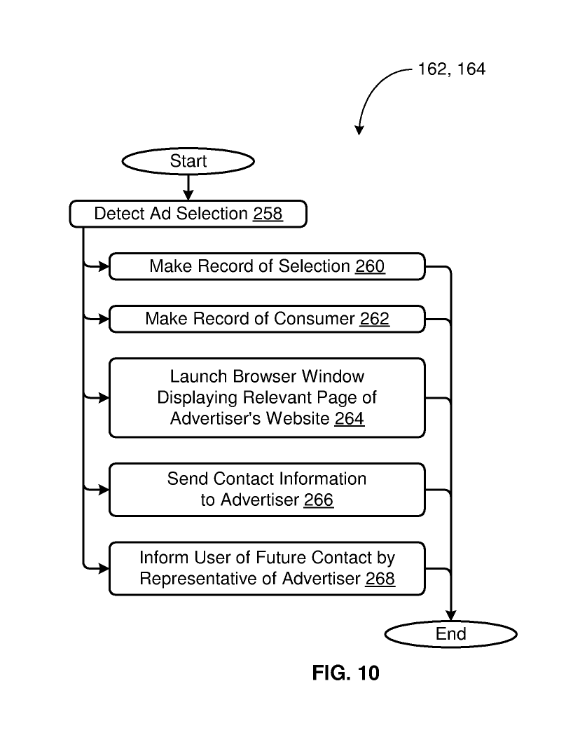

Referring to FIG. 10, upon selection of a collateral ad 116 by a consumer 70, a system 62 in accordance with the present invention may implement various protocols 162, 164. For example, after a selection of an ad 116 is detected 258, the system 62 may make 260 a record of the selection, make 262 a record of the consumer 70 effecting the selection, and launch 264 a browser window displaying a relevant webpage of the advertiser 72.

Alternatively or in combination with the foregoing actions 260, 262, 264, upon selection of a collateral ad 116 by a consumer 70, a system 62 may inform 266 a consumer 70 that he or she will shortly be contacted by the advertiser 70. The system 62 may also send 268 the contact information for the consumer 70 to the advertiser 72. Using that contact information, the advertiser 72 may interact with the consumer 70 directly by email, mail, telephone, facsimile transmission, or the like. For example, an advertiser 72 may use email to deliver a relevant coupon or like. Alternatively, a sales person for the advertiser 72 may contact the consumer 70 to explain the various products or services offered by the advertiser 72.

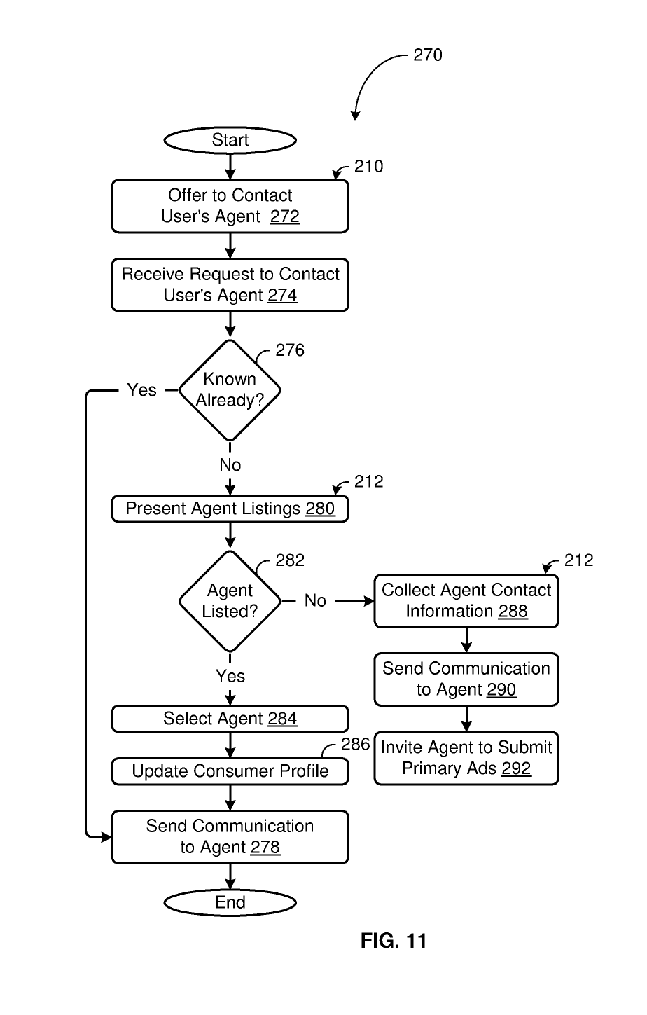

Referring to FIG. 11, in selected embodiments, a system 62 in accordance with the present invention may include, for example, primary ads 110 comprising real estate listings 110. In those embodiments, a method 270 in accordance with the present invention may provide a consumer 70 with useful functionality, while simultaneously growing the number of advertisers 72 (e.g., primary advertisers 72) using the system 62. For example, one of the links presented 210 may be a link offering 272 to contact the real estate agent of a consumer 70. Accordingly, when a consumer locates a primary ad 110 of a property the consumer would like to visit, the consumer 70 may selected the link and so inform the consumer's agent.

When a system 62 in accordance with the present invention receives 274 a request to contact a consumer's agent, the system 62 may determine 276 whether it already “knows” that agent (e.g., has information regarding the consumer's agent stored in the respective consumer profile 92). If the system 62 determines 276 that it indeed already knows the agent to contact, the system 62 may send 278 a communication to that agent.

The nature of such communications may depend on the nature of the agent's relationship with the system 62. For example, agents that are already primary advertisers 72 on the system 62 may receive greater functionality (e.g., the communication may be sent 278 via a text message to the agent's mobile phone rather then simply by email). This may provide a motivation for an agent to become a primary advertiser 72 on the system 62.

Alternatively, if the system 62 determines 276 that it does not already know the agent to contact, the system 62 may prompt 212 a consumer for additional information. For example, the system 62 may present 280 a list of known agents (e.g., agents already registered as primary advertisers 72) within the geographic area surrounding the consumer 70. Accordingly, the consumer 70 may determine 282 whether any of the agents listed is his or her agent. If the consumer's agent is listed, the consumer 70 may select 284 that agent. The profile 92 corresponding to that consumer 70 may be updated 286 and a communication notifying the agent of the consumer's desire to visit the property may be sent 278.

If the consumer's agent is not listed, contact information for the consumer 70 may be forwarded to an agent or agency have purchased the rights to such leads. Alternatively, the consumer 70 may be prompted 212 to enter additional information. For example, the consumer 70 may prompt 212 to collect 288 contact information for the consumer's agent. The system 62 may then send 290 a communication to that agent. In selected embodiments, the communication may inform the agent that the consumer 70 desires to visit a particular property and may provide certain information regarding the property. The communication may also invite 292 the agent to submit primary ads 110 to the system 62.

In selected embodiments, the communication may withhold certain information (e.g., the identity of the property the consumer 70 desires to visit) until the agent registers with the system. That registration may simply require the agent to submit certain information to the system 62, register as a primary advertiser 72, or register as a primary advertiser 72 and actually post a primary ad 110 on the system 62. Accordingly, the system 62 may motivate agents to become familiar with the system 62 and post primary ads 110 thereto.

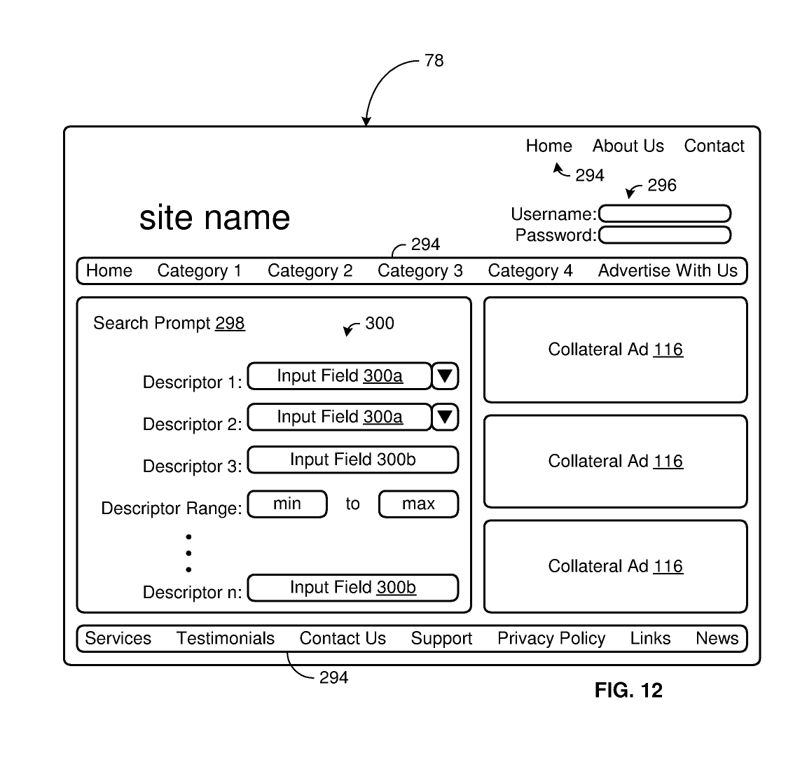

Referring to FIG. 12, a system 62 in accordance with the present invention may include display templates 78 providing any desired look and feel. Moreover, that look and feel may change over time in an effort to stay abreast of current trends and fashions in site design. In selected embodiments, a display template 78 may include one or more menu bars 294. The menu bars 294 may provide prompts or links facilitating navigation between various pages and files offered by a site server 64. A display template 78 may also include a login prompt 296 prompting a user to enter login data 136 such as a username and password.

Certain templates 78 may include a search prompt 298, prompting a user to enter search criteria characterizing the primary ads 110 sought by a consumer 70. For example, a consumer 70 may select a category from a menu bar 294. The consumer 70 may then be presented with a search prompt 298 having input fields 300 with respect to various characteristics of primary ads 110 within that category.

In selected embodiments, descriptor input fields 300 may include one or more drop down input fields 300a wherein a consumer 70 may select from a discreet set of descriptors. A set of input fields 300 may also include one or more textual input fields 300b. In certain embodiments, a textual input field 300b may accept a certain number of digits (e.g., a ZIP code designating a geographic area). Other descriptor input fields 300 may include range fields 300c. For example, in systems 62 wherein the primary ads 110 are property listings, a range field 300c may permit a consumer 70 to select a price range corresponding to the primary ads 110.

A display template 78 may also present or include one or more collateral ads 116. The collateral ads 116 may be presented in close proximity to the search prompt 298. Accordingly, the collateral ads 116 may be readily visible to a consumer 70 entering inputs into a search prompt 298.

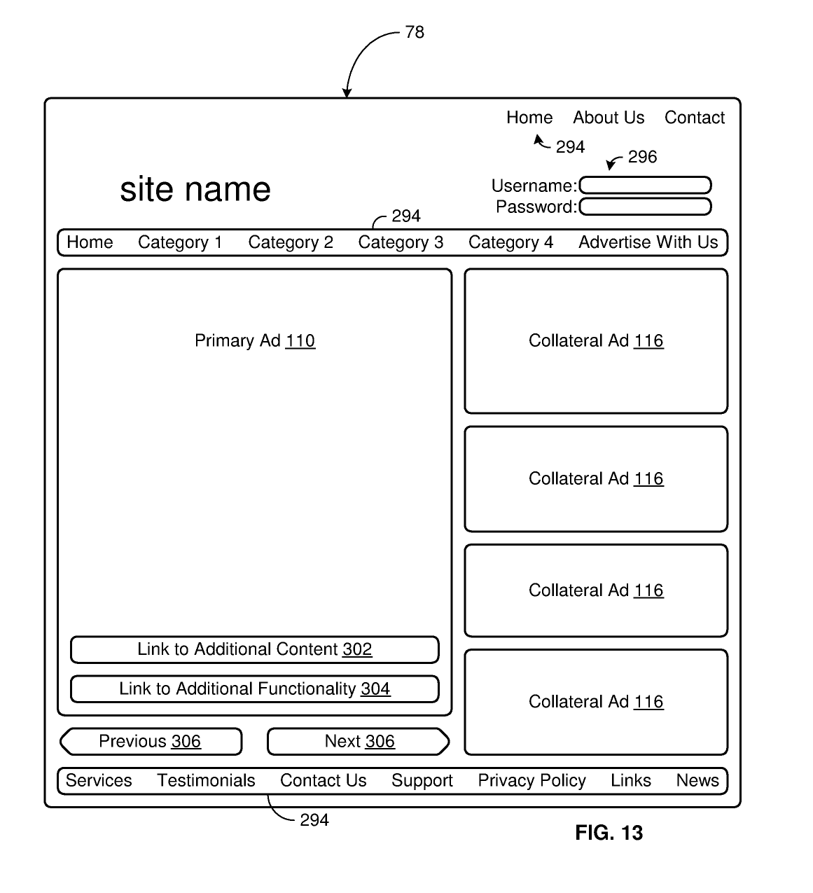

Referring to FIG. 13, once a consumer 70 has identified a primary ad 110 for viewing, that primary ad 110 may be displayed in a prominent position with a display template 78. For example, in one embodiment, the primary ad 110 may be positioned to the left-upper portion of a display template 78. One or more collateral ads 116 may be positioned proximate the primary ad 110, for example, to the right thereof. The primary ad 110 may cover a significantly larger area within the display template 78 than any of the various collateral ads 116. Accordingly, a consumer 70 viewing a primary ad 110 may be able to focus on that ad 110, while also having proximate thereto one or more collateral ads 116.

In conjunction with a primary ad 110, a display template 78 may include one or more links 302, 304 offering additional information or functionality. For example, a primary ad 110 may include a link 302 to additional content describing the characteristics of the goods or services offered in the primary ad 110. Also, a primary ad 110 may include a link 304 to additional functionality facilitating or aiding the consumer 70 in investigating, analyzing, or purchasing the goods or services offered in the primary ad 110. A display template 78 may also include one or more navigation links or functions 306 providing the consumer 70 the ability to advance and retreat within a listing of primary ads 110 identified in the search.

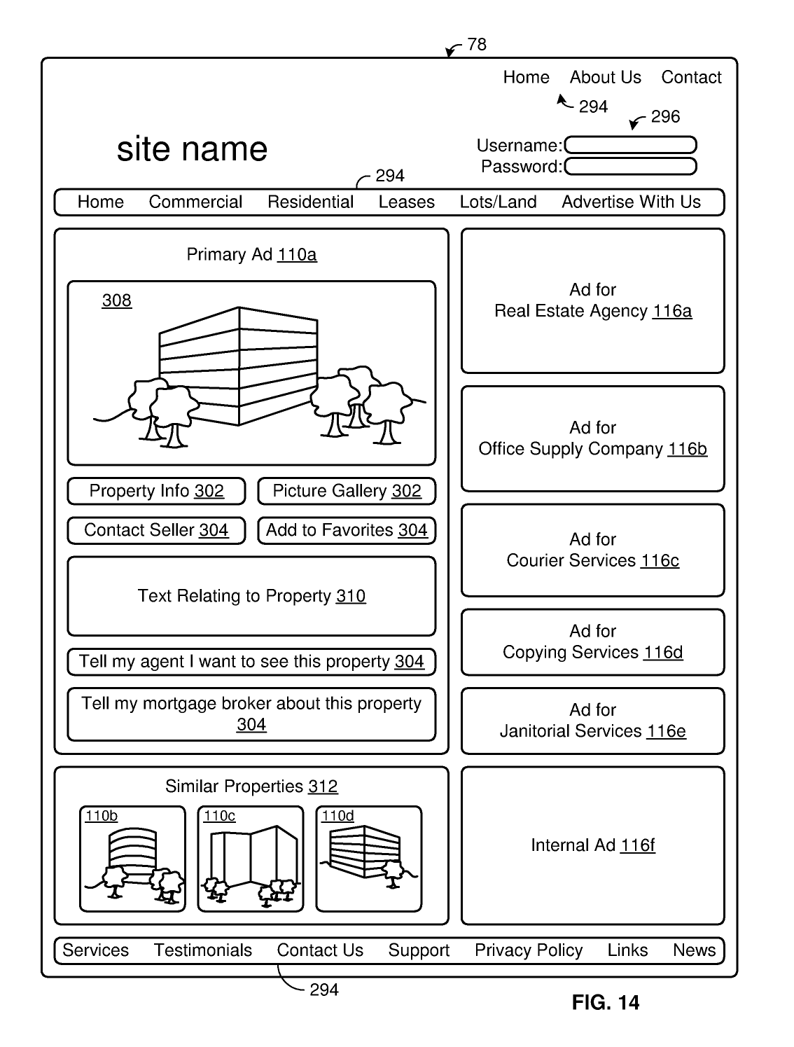

Referring to FIG. 14, in selected embodiments, a display template 78 may be configured to display primary ads 110 corresponding to real estate listings. In such embodiments, a display template 78 may include a photograph 308 (e.g., image data 142) of the property forming the subject of the currently selected or highlighted primary ad 110a. The display template 78 may also include certain text 310 (e.g., text data 144) relating to the property, as well as various links 302, 304 to additional information, photographs, or functionality.

In selected embodiments, if a consumer 70 were to select a link offering additional property information 302 or a picture gallery 302 correspond to the property, the consumer 70 may be prompted 212 to registered with the system 62. Accordingly, a consumer 70 may access certain information on the system 62 before registration and a greater amount of information after registering with, and logging into, the system 62. Similarly, if a consumer 70 were to select a link 304 offering to contact a seller, add the property to the consumer's list of “favorites,” tell an agent that the consumer 70 would like to visit the property, initiate an instant messaging conversation with an agent, or the like, the consumer 70 may be prompted 212 to registered with the system 62 or log in if previously registered.

In selected embodiments, a display template 78 in accordance with the present invention may list 312 or display 312 similar primary ads 110b, 110d, 110d corresponding to the primary ad 110a currently highlighted. These similar ads 110a, 10c, 110d may be other primary ads 110 identified in the search initiated by the consumer 70. Accordingly, the consumer 70 may browse or scroll through these similar ads 110b, 110c, 110d and select those of interest, which may each then be become in turn the currently highlighted primary ad 110a.

The collateral ads 116 displayed in conjunction with a primary ad 110a may be relevant to that primary ad 110a. For example, in the illustrated embodiment, the primary ad 110a may advertise office space within a multi-story office building. Accordingly, the system 62 may retrieve collateral ads 116 having display criteria 160 satisfied by that primary ad 110a. Potentially relevant collateral ads 116 may include an ad 116a for a real estate agency, ad 116b for an office supply company, ad 116c for courier service, ad 116d for a copying service, ad 166e for janitorial services, or the like. Should there be extra space 244 for the display of collateral ads 116, an internal ad 116f may be presented. An internal ad 116f may correspond to the site owner 68 and encourage others to advertise on the system 62.

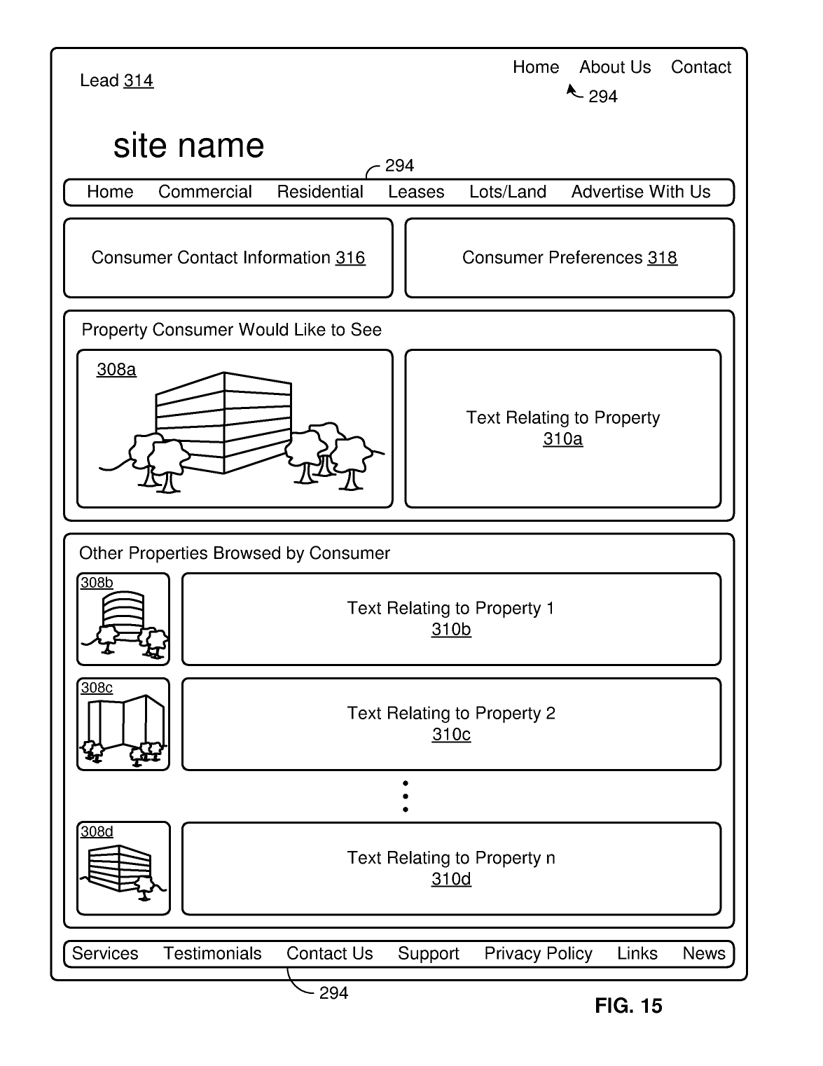

Referring to FIG. 15, in selected embodiments, a system 62 in accordance with the present invention may generate leads 314. A lead 314 may be a compilation of information, for example, information relating to a consumer 70 or an advertiser 72. A system 62 in accordance with the present invention may deliver leads 314 to consumers 70, primary advertisers 72, collateral advertisers 72, and the like, as appropriate.

For example, in systems 62 wherein certain primary ads 110 are real estate listings, a consumer 70 may request that an agent be notified that the consumer 70 would like to visit a particular property. In selected embodiments, an agent (e.g., an agent who is a primary advertiser 72 on the system 62) may be so notified via a lead 314. In some embodiments, a lead 314 may be an interactive email (e.g., an email providing graphics and links tying the agent back into the system 62) sent to the agent. In other embodiments, a lead 314 may be a text message sent to the mobile telephone of the agent.

In one embodiment, a lead 314 may contain contact information 316 for the consumer 70, as well as the preferences 318 of the consumer with respect to when to schedule a visit of the property. A lead 314 may contain a photograph 308a and text 310a relating to the property the consumer desires to visit. In selected embodiments, a lead 314 may also include a photograph 308b, 308c, 308d and text 310b, 310c, 310d relating to other properties (i.e., primary ads 110) recently browsed by the consumer 70. Accordingly, a lead 314 in accordance with the present invention may significantly aid an agent in understanding and meeting the needs of the consumer 70.

The contents of a lead 314 may be tailored to the needs or desires of the receiving party. In certain embodiments, a lead 314 may be provided to a collateral advertiser 72. The lead 314 may provide information that may assist the collateral advertiser 72 in meeting the specific needs of the consumer 70. For example, a lead 314 directed to a collateral advertiser 72 may contain contact information 316 of for the consumer 70, as well as a listing (e.g., photographs 308 and text 310) of a certain number of primary ads 110 recently browsed by the consumer 70. Accordingly, a collateral advertiser 72 may use the lead 314 to tailor its efforts in interacting with the consumer 70, thereby increasing the conversion rate and the value of the advertising provided by the system 62 to the collateral advertiser 72.

In selected embodiments, a lead 314 may be delivered to a consumer 70. For example, a lead 314 may notify a consumer 70 of primary ads 110 recently added to the system 62 that satisfy the criteria set forth in the consumer's contact protocol 140. In certain embodiments, rather than providing the contact information 316 for the consumer 70, a lead 314 may provide the contact information for the consumer's agent, mortgage broker, or the like. Alternatively, a lead may provide collateral ads 116 (e.g., ads 116 for a featured agent, lender, mortgage broker, or the like). Similarly, rather than providing a listing of the primary ads 110 recently viewed by the consumer 70, the lead 314 may provide a listing (e.g., photographs 308 and text 310) of the recently added primary ads 110.

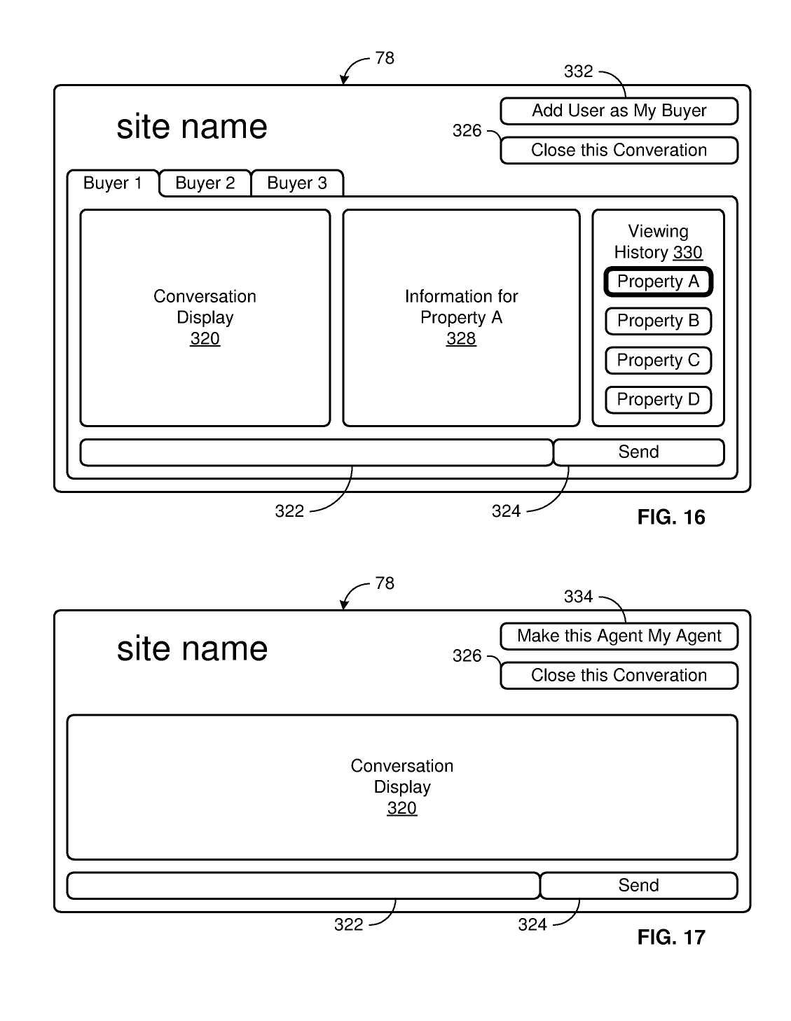

Referring to FIGS. 16 and 17, in selected embodiments, a system 62 in accordance with the present invention may include various features to increase the utility of the system 62 for the various consumers 70 and advertisers 72. In selected embodiments, a system 62 may support personalized sites for certain primary advertisers 72. For example, in a system 62 where selected primary ads 110 are directed to real estate listings, a real estate agent 72 may receive a personalized site. In certain embodiments, the primary ads 110 displayed through such a site may be limited to those posted by the particular primary advertiser 72. Alternatively, any primary ad 110 within the system 62 may be displayed in a personalized site. In selected embodiments, the display template 78 may be designed to promote the primary advertiser 72 associated with the personalized site.

In certain embodiments, a system 72 may be configured to automatically generate primary ads 110 from ads posted on a site belonging to a primary advertiser 72.

Accordingly, as information is updated on the site belonging to the primary advertiser 72, the system 62 may similarly update the primary ads 110 posted on the system 62. In selected embodiments, this may be done by simply pointing the system 62 to the ads on the site of the primary advertiser 72. Accordingly, the display template 78 may be unique to the system 62, but the content (e.g., image data 142, text data 144) may be pulled in real time from the site of the primary advertiser 72.

In selected embodiments, one or more collateral ads 116 may incorporate selected functionality. For example, again using the real estate situation, a real estate agency may act as both a primary advertiser 72 and a collateral advertiser 72. Accordingly, in situations where the agency is acting as a collateral advertiser 72, it may desire to rotate through the agents it highlights in a collateral ad 116. With an agency, there may be serval agents that could be relevant to a particular primary ad 110. Accordingly, a collateral ad 116 may rotate through all the relevant agents to more evenly distribute the benefits to the various agents.

Alternatively, an agency may rotate the agents through a collateral ad 116, but do so in a manner that recognizes the particular skills or availabilities of the different agents. For example, certain agents may have a greater ability to work with certain categories of properties than others. One agent may specialize in homes being sold for more than $1,000,000. Another may specialize in a different market sector. Still others may be currently logged onto the system 62 and in a position to “chat” via an instant messaging utility with a consumer 70. Accordingly, as the various agents are rotated through a particular collateral ad 116, their individual skills, specializations, and availabilities may be considered when determining which agents to display. In effect, the result is a collateral ad 116 with multiple levels of display criteria 160.

In selected embodiments, a system 62 may inform a real estate agent when a particular customer 70 is logged into the system 62. For example, a consumer 70 may have previously informed the system 62 that it was working with a particular agent. However, with the passage of time, the search for a property may have ended without a purchase. Accordingly, if the consumer 70 begins again to log into the system 62, the previous agent may be apprised of the consumer 70 having renewed interest in pursuing a real estate purchase. For example, the agent may be sent a lead 314. Thus, the clients of an agent need not be lost with the passage of time.

A system 62 in accordance with the present invention may include an instant messaging utility. This utility may be presented 210 to a consumer 70 in various situations. For example, when a consumer 70 has specified his or her real estate agent, and that agent is currently logged into the system 62, then the consumer 70 may be presented with the link “chat with my agent.” Alternatively, if a consumer 70 has not specified an agent and there is a relevant agent currently logged into the system 62, a collateral ad 116 advertising that agent (or his or her agency) may include a link inviting the consumer to “chat with an agent.”

In selected embodiments, an instant messaging utility may include an agent-side display template 78 (FIG. 16) and a consumer-side display template 78 (FIG. 17). Both an agent-side template 78 and a consumer-side template 78 may include a conversation display 320 displaying the text of the conversation, a text input field 322, a “send” command 324, and a “close this conversation” command 326.

An agent-side template 78 may permit an agent to toggle between conversations with different buyers (consumers 70). For each consumer 70, an agent-side template 78 may also include a display space 328 showing a primary ad 110 (e.g., real estate property listing 110) the consumer 70 wishes to discuss or is currently viewing. An agent-side template 78 may also include a viewing history 330 listing the various primary ads 110 that a consumer 70 has viewed recently. By selecting one of the primary ads 110 listed in the viewing history, an agent may highlight that ad 110 within the display space 328. Accordingly, the agent may converse more intelligently and effectively with the consumer 70.

In certain embodiments, an instant messaging utility in accordance with the present invention may establish of a link within the system 62 between an agent and a consumer 70. For example, an agent may be given the option 332 to “add this buyer as my client.” Similarly, a consumer 70 may be given the option 334 to “make this agent my agent.” If both agent and consumer select their respective options 332, 334, then the system 62 may establish a link between the two (e.g., update the consumer profile 92 to identify the agent). In selected embodiments, a system 62 may store client information for certain primary advertisers 72. Accordingly, to establish a link between a consumer 70 and an agent that is a primary advertiser 72, the system 62 may update the advertiser profile 90 of the agent 72 to identify the consumer 70. In certain embodiments, the system 62 may permit that agent 72 to export all his or her clients (e.g., linked or identified consumers 70) in a digital “.csv” format. This may facilitate importation of that information into the agent's current customer relationship management (CRM) system.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A system comprising:
a computer network;
a site server hosted on the computer network;
a database hosted on the computer network, the database storing a plurality of primary ads and a plurality of collateral ads, each primary ad of the plurality of primary ads comprising a descriptor, each collateral ad of the plurality of collateral ads comprising a display criterion;
the site server programmed to receive a query and identify from the database primary ads of the plurality of primary ads satisfying the query;
the site server further programmed to identify from the database collateral ads of the plurality of collateral ads having a display criterion satisfied by the descriptor of at least one primary ad of the identified primary ads; and
the site server further programmed to simultaneously display the at least one primary ad and at least one collateral ad of the identified collateral ads.

2. The system of claim 1, wherein the site server is further programmed to assign a greater display area to the at least one primary ad than to the at least one collateral ads.

3. The system of claim 2, wherein the at least one primary ad comprises a real estate listing.

4. The system of claim 3, wherein the real estate listing is an offer to sell a real property.

5. The system of claim 3, wherein the real estate listing is an offer to lease a real property.

6. The system of claim 3, wherein the descriptor of the at least one primary ad describes a characteristic of the real property.

7. The system of claim 6, wherein the descriptor comprises an SIC code.

8. The system of claim 7, wherein the display criterion comprises at least one of an SIC code data and a range.

9. The system of claim 8, wherein the range corresponds to a price.

10. The system of claim 1, wherein each primary ad of the plurality of primary ads comprises a descriptor in the form of an SIC code.

11. The system of claim 10, wherein each collateral ad of the plurality of collateral ads comprises a display criterion in the form of an SIC code;

12. The system of claim 11, wherein the site server is further programmed to identify from the database collateral ads of the plurality of collateral ads having an SIC code matching the SIC code of at least one primary ad of the identified primary ads.

13. The system of claim 1, wherein the site server is further programmed to simultaneously display the at least one primary ad and multiple collateral ads of the identified collateral ads.

14. A system comprising:
a computer network;
a site server hosted on the computer network;
a database hosted on the computer network, the database storing records comprising a primary ad and a plurality of collateral ads, the primary ad having associated therewith at least one SIC code, each collateral ad having associated therewith at least one SIC code;
the site server programmed to identify from the database collateral ads of the plurality of collateral ads wherein the at least one SIC code thereof matches the at least one SIC code of the primary ad;
the site server further programmed to simultaneously display the primary ad and at least one collateral ad of the identified collateral ads.

15. A system comprising:
a computer network;
a site server hosted on the computer network;
a database hosted on the computer network, the database storing records comprising a primary ad and a plurality of collateral ads, the primary ad having associated therewith at least one SIC code and at least one descriptor, each collateral ad of the plurality of collateral ads having associated therewith at least one SIC code and at least one display criterion;
the site server programmed to identify from the database collateral ads of the plurality of collateral ads wherein the at least SIC code thereof matches the at least one SIC code of the primary ad and wherein the at least one display criterion is satisfied by the at least one descriptor;
the site server further programmed to simultaneously display the primary ad and at least one collateral ad of the identified collateral ads.
